(19) United States
(12) Patent Application Publication
(10) Pub. No.: US 2005/0214487 A1
(43) Pub. Date: Sep. 29, 2005

(54) Method for producing bent hollow profile strips and resulting glazing

(75) Inventor: Hans Trautz, Pforzheim (DE)

Correspondence Address: YOUNG & THOMPSON, 745 SOUTH 23RD STREET, 2ND FLOOR, ARLINGTON, VA, 22202, US

(73) Assignee: SAINT-GOBAIN VITRAGE SUISSE AG, BERNE (CH)

(21) Appl. No.: 10/983,885

(22) Filed: Nov. 9, 2004

Related U.S. Application Data
(63) Continuation of application No. 09/403,977, filed on Oct. 29, 1999, now abandoned.

(30) Foreign Application Priority Data
May 1, 1997 (EP) 97810276.2

(51) Int. Cl. B21B 37/48; E06B 3/24; E06B 3/26; E06B 3/28; B65D 1/00; F16L 1/00; B32B 1/08; B29D 22/00; B29D 23/00; B32B 3/10

(52) U.S. Cl. 428/34; 428/36.3

(57) ABSTRACT

A hollow plastic strip is placed in a bending device. The bend point is heated. The strip is bent and plastic materials is introduced into the bent area on both sides of this area to reinforce it. The hollow plastic strip with reinforced corners can be used as a spacer in multi-pane insulating glazing.

The present invention refers to a method for producing bent hollow profile strips according to the preamble of claim 1 for use as plastic spacers for a multi-pane insulating glazing.

Such manufacturing method is known from the EP-A-0 103 111, where a connecting body of an adhesive material connects two hollow profiles while an adhesive of this kind can also be used in order to reinforce comers. These connections replace socket connections and are intended for metal profiles.

In many applications of hollow profile strips, more particularly if they are used for the manufacture of spacer frames for multi-pane insulating glazings, it is important that the outwardly facing surface of the frame is tight, and it has therefore been attempted to produce the frames by bending a strip instead of assembling individual strips.

In the manufacture of frames from metal profiles, mostly of aluminum, a method for producing a spacer frame is e.g. known from the EP-A-003 715, where the inwardly facing wall section of the profile bar is cut transversally to its longitudinal extension before being bent. The purpose of this incision is to prevent upsets at the comer when the bar is bent.

WO-93/20319 discloses a method for producing spacer frames where the frame is filled with a granular drying agent prior to bending, the drying agent being previously mixed with a compressible granulate. Subsequently, the metallic profile frame is bent. In the process, the bend points may be weakened especially in the case of thin-walled strips.

While spacer frames of metal have been known for quit a long time, and bending methods for the same have therefore been well studied, further difficulties are encountered in the manufacture of spacer frames of plastic materials since bending hollow profile strips without upsetting and especially also without weakening them e.g. by sawed or punched cuts in the inner edge of the frame is very problematic.

On the background of this prior art and of the described problems, it is the object of the present invention to provide a method for producing bent hollow profile strips from plastic materials in which the resulting frame offers a sufficient stability for the intended purposes at the bend points and conserves the required shape. In particular, it is also an object of the present invention to provide a method which allows to form frames from spacers of thermoplastic materials for a multi-pane insulating glazing according to the DE-A-195 33 685 whose comers fulfill the requirements with respect to stability and dimensional accuracy, and which comprise clean and acute angles in a further development of the invention. These objects are attained by the defined in the independent claims.

The invention is explained in more detail hereinafter with reference to a drawing of an exemplary embodiment where the figures show different steps of the process of the invention for reinforcing a bend point and for bending a hollow profile strip which may subsequently for a frame.

FIG. 1 shows a perspective view of a profile strip;

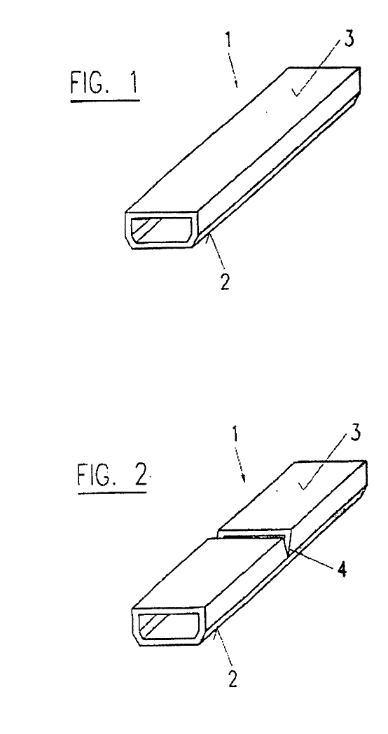

FIG. 2 shows the strip of FIG. 1 with an incision;

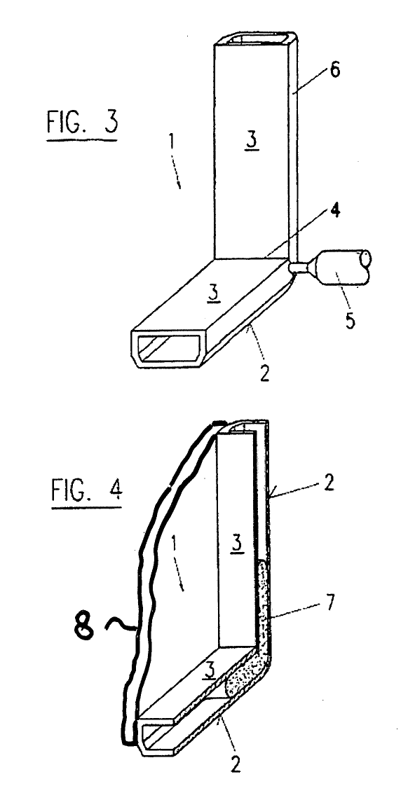

FIG. 3 shows the bent profile strip with a schematically illustrated injection nozzle applied thereto; and

FIG. 4 shows a longitudinal cross-section of the finished bent strip with the reinforced corner.

FIG. 1 shows a hollow profile strip 1, which is simplified and schematically illustrated for better understanding, but which may be shaped and designed according to the above-mentioned DE-A-195 33 685 and may e.g. consist of a glass-fiber reinforced plastic material, and whose external side 2 may be provided with a bonded metal foil. As far as the method defined in claim 1 is concerned, the strip may also be of metal. Hereinafter, hollow profile strip 1 will briefly be referred to as strip 1.

Such a strip 1 can be supplied automatically from a shelf of a bending device to the milling and cutting installation of the automatic bending device, were it is automatically connected by means of a longitudinal connector to the remainder of the preceding strip to form an endless strip, if necessary. While metering the required strip length for the frame to be produced, the strip is topped at the first bend point by the electronic cutting and milling installation where an incision 4 is made in the internal side of 3 of the strip while observing a defined cutting depth.

Of course, incision 4 can also be made by the saw blade, which can be used for this purpose by adjusting its cutting depth. The incision is made at every bend point of the strip. The shape and the depth of the incision essentially depend on the angle to be bent, the V-shaped incision which is schematically shown in FIG. 2 being intended for a 90° bend. After the last bend milling, the strip is sawed off by the saw blade at the required length.

The bending operation is effected in the subsequently described steps. First, the strip is transported to the first bending position in the bending tool of the bending device, and when the bend point is attained, it is chucked in a clamping device in front of and after the bend point. Then, the wall of the strip is preheated at the bend point, where e.g. a first hot-air nozzle (not shown) is pointed at the bend point from below and a second hot-air nozzle (not shown) is positioned at the bend point directly through incision 4 in the strip. After the desired and adjustable preheating time, the hot-air is turned off, and the nozzles are swung out of the bending area.

After the heating operation, the clamping jaws are displaced to the bending position, and then the bending jaw of the bending tool is displaced to the desired angular position, which may be equal to or different from 90°. At the start of the bending operation, a heated injection nozzle 5 is pushed through a transversal wall 6 at the bend point of the strip. As soon as the required bending angle is attained, while the nozzle has punctured the strip wall, the injection of a thermoplastic material 7, e.g. as known under the abbreviations SAN, ABS, and possibly glass-fiber reinforced, is started. The injected quantity of the material can be regulated automatically. The injecting position, resp. the injecting angle are chosen such that the plastic reinforcing mass is regularly distributed inside the profile on both sides of the corner.

At the beginning of the injection, the injection nozzle is retracted a distance which corresponds to the wall thickness so that the hole produced in the strip due to the injection is automatically filled with plastic material 7. In the case of a metallic strip, an already existing drilling hole having served for the removal of drying agent grains may be used for the injection, for example.

In analogy to an injection molding tool, the clamping unit is cooled. After the cooling time, the bending tool returns to the initial position, and the strip is transported to the next bending corner. This procedure is repeated until the frame is finished.

In the implementation of the method of the invention, it is not essential whether the drying agent grains are filler in before or after bending the frame. If the grains have been filled in beforehand, they must be able to yield during the injection of the reinforcing mass, or they are evacuated.

As previously mentioned, the injection of the corner reinforcement can be advantageous for all hollow profile strips, however especially if thermoplastic materials with or without reinforcing materials are used. Also, especially in the case of hollow profile strips of plastic materials, the incision on the inner side of the bend point offers further advantage.

1. A method for producing a double glazing having a reinforced, bent hollow strip frame, comprising the sequential steps of:
removing a V-shaped portion from a hollow fiberglass-reinforced plastic strip, the V-shaped portion being removed at a bend point of the strip, the removal of the V-shaped portion leaving a notch with exposed edges;
heating the bend point;
bending the strip at the bend point to bring the exposed edges of the notch together to form a seam line at a bend area;
pushing a heated injection nozzle through the strip at the bend area to create an injection hole;
using the injection nozzle, injecting a plastic material, through the hole, into a hollow section of the strip at the bend point and on both sides of the bend area in order to reinforce the bend area of the strip;
using the injection nozzle to fill the hole.

2. The method of claim 1, comprising the further step of:
attaching a glass sheet to each side of the strip at the bend area to form a double glazing.

3. The method of claim 1, wherein the plastic material is fiberglass reinforced.

4. The method of claim 1, wherein the plastic material is thermoplastic and fiberglass reinforced.

5. A method of claim 1, wherein the plastic material is introduced into the hollow section on both sides of the bend point.

6. A glazing frame, comprising:
a frame comprising a hollow fiberglass-reinforced plastic strip with four plastic-filled reinforced corners,
the strip having a closed outer perimeter and an outer edge joining two opposite sides,
the strip having a hollow interior in regions apart from the four corners,
each corner having
i) a bend line at the outer edge,
ii) a seam line extending, on each of the opposite sides, from the bend line to an interior perimeter of the frame with two edges of the strip being adjacently located to form each seam line,
iii) a plastic-filled hole penetrating through one of the opposite sides, and
iv) a plastic-filled reinforced region filling an interior of the strip at the corner and on both sides of the seam line and the bend line, the reinforced region reinforcing the frame at the corner.

7. The glazing of claim 6, further comprising:
a glass sheet affixed to each of the two opposite sides.

8. The glazing of claim 6, wherein the plastic material is fiberglass reinforced.

9. The glazing according to claim 6, wherein the plastic material comprises a thermoplastic material with fiber reinforcement.

10. The glazing according to claim 6, wherein the plastic material comprises a thermoplastic material without fiber reinforcement.

11. The glazing of claim 6, wherein there are two plastic-filed holes at each corner.
